(19) United States
(12) Patent Application Publication
(10) Pub. No.: US 2015/0164107 A1
(43) Pub. Date: Jun. 18, 2015

(54) FROZEN DESSERT MIXES USING PULSE PROTEIN PRODUCTS

(71) Applicant: BURCON NUTRASCIENCE (MB) CORP., Winnipeg (CA)

(72) Inventors: Sarah Medina, Winnipeg (CA); Kevin I. Segall, Winnipeg (CA)

(73) Assignee: BURCON NUTRASCIENCE (MB) CORP., Winnipeg, MB (CA)

(21) Appl. No.: 14/413,668

(22) PCT Filed: Jul. 8, 2013
(86) PCT No.: PCT/CA2013/000626

§ 371 Date: Jan. 8, 2015

Related U.S. Application Data
(60) Provisional application No. 61/669,292, filed on Jul. 9, 2012.

(51) Int. Cl. A23G 9/38

(52) U.S. Cl. CPC A23G 9/38; A23V 2002/00

(57) ABSTRACT

Pulse protein products having a protein content of at least about 60 wt % (N×6.25) d.b., preferably at least about 90 wt %, and being soluble at pH values of less than about 4.4 and heat stable at such pH values, or alternatively adjusted in pH to a pH of about 6 to about 8 and further processed by drying the product, recovering and drying any precipitated pulse protein material, heat treating and then drying the product, or heat treating the product and recovering and drying any precipitated pulse protein material are used to provide, at least in part, the protein component of a dairy analogue, dairy alternative or plant/dairy blend frozen dessert mix.

### REFERENCE TO RELATED APPLICATION

This application claims priority under 35 USC 119(e) from U.S. Provisional Patent Application No. 61/669,292 filed Jul. 9, 2012.

### FIELD OF INVENTION

This invention relates to the mixes used in the preparation of frozen dessert products, including non-dairy products, prepared with a pulse protein product, particularly an isolate.

### BACKGROUND TO THE INVENTION

In U.S. patent application Ser. No. 13/103,528 filed May 9, 2011 (US Patent Application Publication No. 2011-0274797 published Nov. 10, 2011), Ser. No. 13/289,264 filed Nov. 4, 2011 (US Patent Application Publication No. 2012/0135117 published May 31, 2012), Ser. No. 13/556,357 filed Jul. 24, 2012 and Ser. No. 13/642,003 filed Jan. 7, 2013, assigned to the assignee hereof and the disclosures of which are incorporated herein by reference, there is described the production of pulse protein products having a protein content of at least about 60 wt % (N×6.25) d.b., preferably at least about 90 wt %, more preferably at least about 100 wt %, that produce preferably transparent, heat stable solutions at low pH values and, therefore, may be used for protein fortification of, in particular, soft drinks and sports drinks, as well as other aqueous systems, without precipitation of protein.

The pulse protein product described therein has a unique combination of parameters, not found with other pulse protein products. The product is completely soluble in aqueous solution at acid pH value of less than about 4.4 and is heat stable in that pH range permitting thermal processing of aqueous solutions of the product. Given the complete solubility of the product, no stabilizers or other additives are necessary to maintain the protein in solution or suspension.

The pulse protein product in one aspect, is produced by a process which comprises:
(a) extracting a pulse protein source with an aqueous calcium salt solution, preferably an aqueous calcium chloride solution, to cause solubilization of pulse protein from the protein source and to form an aqueous pulse protein solution,
(b) separating the aqueous pulse protein solution from residual pulse protein source,
(c) optionally diluting the aqueous pulse protein solution,
(d) adjusting the pH of the aqueous pulse protein solution to a pH of about 1.5 to about 4.4, preferably about 2 to about 4, to produce an acidified aqueous pulse protein solution,
(e) optionally clarifying the acidified aqueous pulse protein solution if it is not already clear,
(f) optionally concentrating the acidified aqueous pulse protein solution while maintaining the ionic strength substantially constant by using a selective membrane technique,
(g) optionally diafiltering the concentrated pulse protein solution, and
(h) optionally drying the concentrated and optionally diafiltered pulse protein solution.

The pulse protein product preferably is an isolate having a protein content of at least about 90 wt %, preferably at least about 100 wt %.

Optionally, the separation step (b) may be effected following the pH adjusting step (d).

In U.S. Provisional Patent Application No. 61/669,845 filed Jul. 10, 2012, assigned to the assignee hereof and the disclosure of which is incorporated herein by reference, the optionally concentrated and optionally diafiltered aqueous protein solution resulting from the aforementioned U.S. patent application Ser. Nos. 13/103,528, 13/289,264, 13/556,357 and 13/642,003 or a solution prepared by rehydrating dried pulse protein product from the process of the aforementioned U.S. patent application Ser. Nos. 13/103,528, 13/289,264, 13/556,357 and 13/642,003 is adjusted to a pH in the range of about 6 to about 8, preferably about 6.5 to about 7.5 and either the resulting product is dried or any precipitate which forms is separated and dried. The pulse protein products provided thereby have a clean flavor and are useful in food applications under neutral or near neutral conditions.

Accordingly, in an aspect of the invention described in the aforementioned U.S. Patent Application No. 61/669,845, there is provided a method of producing the pulse protein product, which comprises:
(a) providing an aqueous solution of a pulse protein product having a protein content of at least about 60 wt % (N×6.25) d.b. which is completely soluble in aqueous media at a pH of less than about 4.4 and heat stable at that pH range,
(b) adjusting the pH of the solution to about pH 6 to about 8, preferably about 6.5 to about 7.5 and,
(c) optionally drying the entire pH adjusted sample, or
(d) optionally recovering and drying any precipitated pulse protein material, or
(e) optionally heat treating the pH-adjusted solution and then drying the entire sample, or
(f) optionally heat treating the pH-adjusted solution then recovering and drying any precipitated pulse protein material.

In another aspect of the invention described in U.S. 61/669,845, the concentrated pulse protein solution produced according to the procedure of above-noted U.S. patent applications may be processed to produce the pH-adjusted pulse protein products provided herein. Accordingly, in a further aspect of the invention described in U.S. 61/669,845, there is provided a method of producing the pulse protein product, which comprises:
(a) extracting a pulse protein source with an aqueous calcium salt solution, particularly calcium chloride solution, to cause solubilization of pulse protein from the protein source and to form an aqueous pulse protein solution,
(b) separating the aqueous pulse protein solution from residual protein source,
(c) optionally diluting the aqueous pulse protein solution,
(d) adjusting the pH of the aqueous pulse protein solution to a pH of about 1.5 to about 4.4, preferably about 2 to about 4, to produce an acidified aqueous pulse protein solution,
(e) optionally heat treating the acidified aqueous pulse protein solution while maintaining the ionic strength substantially constant by using a selective membrane technique,
(f) optionally concentrating the acidified aqueous pulse protein solution while maintaining the ionic strength substantially constant by using a selective membrane technique,
(g) optionally diafiltering the concentrated pulse protein solution,
(h) optionally pasteurizing the concentrated pulse protein solution to reduce the microbial load,
(i) adjusting the pH of the aqueous pulse protein solution to about pH 6 to about 8, preferably about 6.5 to about 7.5 and
optionally drying the entire pH adjusted sample or
optionally recovering and drying any precipitated pulse protein material or optionally heat treating the pH-adjusted solution and then drying the entire sample or
optionally heat treating the pH-adjusted solution then recovering and rying any precipitated pulse protein material.

### SUMMARY OF THE INVENTION

It has now been found that the novel pulse protein products described in the aforementioned U.S. patent application Ser. Nos. 13/103,528, 13/289,364, 13/536,357, 13/642,003 and 61/669,845 may be effectively used in frozen dessert mixes, including non-dairy products or products that are blends of dairy and plant ingredients, as an at least partial substitute for conventional proteinaceous materials derived from milk, soy or other sources, and provide frozen dessert mixes having good flavor properties. Such frozen dessert mixes may then be frozen in the preparation of frozen dessert products, which also have good flavour properties. Such frozen dessert products include but are not limited to scoopable frozen desserts, soft serve frozen desserts and frozen novelty products, such as molded or extruded products that may or may not be provided on sticks. Such frozen dessert products may contain any manner of inclusion, such as syrups, fruits, nuts and/or particulates, or coatings in the case of the frozen novelty products, in combination with the frozen dessert mix.

In very general terms, frozen dessert mixes, be they dairy, non-dairy or blends, all typically comprise water, protein, fat, flavourings, sweetener and other solids along with stabilizers and emulsifiers. The proportions of these components vary depending on the desired composition of the frozen dessert product. The range of dairy analogue or dairy alternative or plant/dairy blend frozen dessert products that may be prepared from dairy analogue or dairy alternative or plant/dairy frozen dessert mixes may be considered to be equivalent to the range of frozen dairy dessert products that may be prepared from frozen dairy dessert mixes.

Suggested mix compositions for a variety of frozen dairy desserts can be found at http://www.uoguelph.ca/foodscience/dairy-science-and-technology/dairy-products/ice-cream/ice-ream-formulations/suggested-mixes (Professor H. Douglas Goff, Dairy Science and Technology Education Series, University of Guelph, Canada). To illustrate the differences in composition between some various types of frozen dairy dessert mixes, sample compositions from this reference are shown below in Tables 1 to 6.

TABLE 1
Sample suggested mix composition
for hard frozen ice cream product

| Component | % by weight |
|---|---|
| Milkfat | 10.0 |
| Milk solids-not-fat*¹ | 11.0 |
| Sucrose | 10.0 |
| Corn Syrup Solids | 5.0 |
| Stabilizer | 0.35 |
| Emulsifier | 0.15 |
| Water | 63.5 |

*¹Proteins are a component of this phase along with other species contributed by the milk such as lactose and salts. The protein content of the milk solids-not-fat is on average 38%(http://www.uoguelph.ca/foodscience/dairy-science-and-technology/dairy-products/ice-cream/ice-cream-formulations/ice-cream-mix-general-c (Professor H. Douglas Goff, Dairy Science and Technology Education Series, University of Guelph, Canada)). Based on this value, the protein content of the above ice cream mix is approximately 4.18% by weight.

TABLE 2
Sample suggested mix composition for low fat ice cream product

| Component | % by weight |
|---|---|
| Milkfat | 3.0 |
| Milk solids-not-fat*¹ | 13.0 |
| Sucrose | 11.0 |
| Corn Syrup Solids | 6.0 |
| Stabilizer | 0.35 |
| Emulsifier | 0.10 |
| Water | 66.35 |

*¹Based on a milk solids-not-fat protein content of 38%, the protein content of the above low fat ice cream mix is approximately 4.94% by weight.

TABLE 3
Sample suggested mix composition for light ice cream product

| Component | % by weight |
|---|---|
| Milkfat | 6.0 |
| Milk solids-not-fat*¹ | 12.0 |
| Sucrose | 13.0 |
| Corn Syrup Solids | 4.0 |
| Stabilizer | 0.35 |
| Emulsifier | 0.15 |
| Water | 64.5 |

*¹Based on a milk solids-not-fat protein content of 38%, the protein content of the above light ice cream mix is approximately 4.56% by weight.

TABLE 4
Sample suggested mix composition
for soft frozen ice cream product

| Component | % by weight |
|---|---|
| Milkfat | 10.0 |
| Milk solids-not-fat*¹ | 12.5 |
| Sucrose | 13.0 |
| Stabilizer | 0.35 |
| Emulsifier | 0.15 |
| Water | 64.0 |

*¹Based on a milk solids-not-fat protein content of 38%, the protein content of the above ice cream mix is approximately 4.75% by weight.

TABLE 5
Sample suggested mix composition for sherbet*¹

| Component | % by weight |
|---|---|
| Milkfat | 0.5 |
| Milk solids-not-fat*² | 2.0 |
| Sucrose | 24.0 |
| Corn Syrup Solids | 9.0 |
| Stabilizer/Emulsifier | 0.30 |
| Citric acid (50% sol.) *³ | 0.70 |
| Water | 63.5 |

*¹Fruit is added at about 25% to the mix.
*²Based on a milk solids-not-fat protein content of 38%, the protein content of the above sherbet mix is approximately 0.76% by weight.
*³ Acid is added just before freezing after aging of the mix.

TABLE 6
Sample suggested mix composition for frozen yogurt

| Component | % by weight |
|---|---|
| Milkfat | 2.0 |
| Milk solids-not-fat*¹ | 14.0 |
| Sugar | 15.0 |
| Stabilizer | 0.35 |
| Water | 68.65 |

*¹Based on a milk solids-not-fat protein content of 38%, the protein content of the above frozen yogurt mix is approximately 5.32% by weight.

As mentioned above, the proportion of components in frozen dessert mixes, may vary similarly to the proportions of components in frozen dairy dessert mixes. Frozen dairy dessert mixes utilize dairy sources of fat and protein/solids. Frozen dessert mixes may be non-dairy or utilize a blend of dairy and plant ingredients.

The typical types of ingredients used in frozen dessert mix formulations are described below. Other types of ingredients not mentioned may also be used in frozen dessert mix formulations.

The fat source used for the frozen dessert mixes may be any convenient food grade dairy or plant derived fat source or blend of fat sources. Suitable fat sources include but are not limited to milk, cream, butteroil, soy milk, soy oil, coconut oil and palm oil. It should be noted that certain ingredients may provide multiple components to the formulations. For example, the inclusion of milk or soymilk in the formulation provides fat, protein, other solids and water. The fat level in the frozen dessert mixes may range from about 0 to about 30 wt %, preferably about 0 to about 18 wt %.

The protein source used for the frozen dessert mixes may be any convenient food grade dairy or plant derived protein source or blend of protein sources. Suitable protein sources include but are not limited to cream, milk, skim milk powder, whey protein concentrate, whey protein isolate, soy protein concentrate and soy protein isolate. As mentioned above, certain ingredients may provide multiple components, including protein to the formulation. The protein level in the frozen dessert may range from about 0.1 to about 18 wt %, preferably about 0.1 to about 6 wt %.

The choice and level of sweetener or sweeteners used in the frozen dessert mixes will influence factors such as the sweetness, caloric value, and texture of the frozen dessert product. Various sweeteners may be utilized in the frozen dessert mixes, including but not limited to sucrose, corn syrup derived ingredients, sugar alcohols, sucralose and acesulfame potassium. Blends of sweeteners are often used to get the desired qualities in the final product. The overall level of added sweetener in the frozen dessert mixes may range from about 0 to about 45 wt %, preferably about 0 to about 35 wt %.

Stabilizers used in the frozen dessert mixes may include but are not limited to locust bean gum, guar gum, carrageenan, carboxymethyl cellulose and gelatin. The stabilizer level in the frozen dessert mixes may be about 0% to about 3%, preferably about 0% to about 1%.

Emulsifiers used in the frozen dessert mixes may include but are not limited to egg yolk, monoglycerides, diglycerides and polysorbate 80. The emulsifier level in the frozen dessert mixes may range from about 0% to about 4%, preferably about 0% to about 2%.

In the present invention, the proteinaceous ingredients used to supply protein to the frozen dessert mix compositions are at least partially replaced by the novel pulse protein products described above.

### GENERAL DESCRIPTION OF INVENTION

The initial step of the process of providing the pulse protein products for use herein involves solubilizing pulse protein from a pulse protein source. The pulses to which the invention may be applied include, but are not limited to lentils, chickpeas, dry peas and dry beans. The pulse protein source may be pulses or any pulse product or by-product derived from the processing of pulses. For example, the pulse protein source may be a flour prepared by grinding an optionally dehulled pulse. As another example, the pulse protein source may be a protein-rich pulse fraction formed by dehulling and grinding a pulse and then air classifying the dehulled and ground material into starch-rich and protein-rich fractions. The pulse protein product recovered from the pulse protein source may be the protein naturally occurring in pulses or the proteinaceous material may be a protein modified by genetic manipulation but possessing characteristic hydrophobic and polar properties of the natural protein.

Protein solubilization from the pulse protein source material is effected most conveniently using calcium chloride solution, although solutions of other calcium salts, may be used. In addition, other alkaline earth metal compounds may be used, such as magnesium salts. Further, extraction of the pulse protein from the pulse protein source may be effected using calcium salt solution in combination with another salt solution, such as sodium chloride. Additionally, extraction of the pulse protein from the pulse protein source may be effected using water or other salt solution, such as sodium chloride, with calcium salt subsequently being added to the aqueous pulse protein solution produced in the extraction step. Precipitate formed upon addition of the calcium salt is removed prior to subsequent processing.

As the concentration of the calcium salt solution increases, the degree of solubilization of protein from the pulse protein source initially increases until a maximum value is achieved. Any subsequent increase in salt concentration does not increase the total protein solubilized. The concentration of calcium salt solution which causes maximum protein solubilization varies depending on the salt concerned. It is usually preferred to utilize a concentration value less than about 1.0 M, and more preferably a value of about 0.10 to about 0.15 M.

In a batch process, the salt solubilization of the protein is effected at a temperature of from about 1° to about 100° C., preferably about 15° C. to about 65° C., more preferably about 20° to about 35° C., preferably accompanied by agitation to decrease the solubilization time, which is usually about 1 to about 60 minutes. It is preferred to effect the solubilization to extract substantially as much protein from the pulse protein source as is practicable, so as to provide an overall high product yield.

In a continuous process, the extraction of the protein from the pulse protein source is carried out in any manner consistent with effecting a continuous extraction of protein from the pulse protein source. In one embodiment, the pulse protein source is continuously mixed with the calcium salt solution and the mixture is conveyed through a pipe or conduit having a length and at a flow rate for a residence time sufficient to effect the desired extraction in accordance with the parameters described herein. In such a continuous procedure, the salt solubilization step is effected in a time of about 1 minute to about 60 minutes, preferably to effect solubilization to extract substantially as much protein from the pulse protein source as is practicable. The solubilization in the continuous procedure is effected at temperatures between about 1° and about 100° C., preferably between about 15° C. and about 65° C., more preferably between about 20° and about 35° C.

The extraction is generally conducted at a pH of about 4.5 to about 11, preferably about 5 to about 7. The pH of the extraction system (pulse protein source and calcium salt solution) may be adjusted to any desired value within the range of about 4.5 to about 11 for use in the extraction step by the use of any convenient food grade acid, usually hydrochloric acid or phosphoric acid, or food grade alkali, usually sodium hydroxide, as required.

The concentration of pulse protein source in the calcium salt solution during the solubilization step may vary widely. Typical concentration values are about 5 to about 15% w/v.

The protein extraction step with the aqueous salt solution has the additional effect of solubilizing fats which may be present in the pulse protein source, which then results in the fats being present in the aqueous phase.

The protein solution resulting from the extraction step generally has a protein concentration of about 5 to about 50 g/L, preferably about 10 to about 50 g/L.

The aqueous calcium salt solution may contain an antioxidant. The antioxidant may be any convenient antioxidant, such as sodium sulfite or ascorbic acid. The quantity of antioxidant employed may vary from about 0.01 to about 1 wt % of the solution, preferably about 0.05 wt %. The antioxidant serves to inhibit oxidation of any phenolics in the protein solution.

The aqueous phase resulting from the extraction step then may be separated from the residual pulse protein source, in any convenient manner, such as by employing a decanter centrifuge, followed by disc centrifugation and/or filtration, to remove residual pulse protein source material. The separation step may be conducted at any temperature within the range of about 1° to about 100° C., preferably about 15° to about 65° C., more preferably about 50° to about 60° C. Alternatively, the optional dilution and acidification steps described below may be applied to the mixture of aqueous pulse protein solution and residual pulse protein source, with subsequent removal of the residual pulse protein source material by the separation step described above. The separated residual pulse protein source may be dried for disposal or further processed, such as to recover starch and/or residual protein. Residual protein may be recovered by re-extracting the separated residual pulse protein source with fresh calcium salt solution and the protein solution yielded upon clarification combined with the initial protein solution for further processing as described below. Alternatively, the separated residual pulse protein source may be processed by a conventional isoelectric precipitation process or any other convenient procedure to recover residual protein.

The aqueous pulse protein solution may be treated with an anti-foamer, such as any suitable food-grade, non-silicone based anti-foamer, to reduce the volume of foam formed upon further processing. The quantity of anti-foamer employed is generally greater than about 0.0003% w/v. Alternatively, the anti-foamer in the quantity described may be added in the extraction steps.

The separated aqueous pulse protein solution may be subject to a defatting operation, if required, as described in U.S. Pat. Nos. 5,844,086 and 6,005,076, assigned to the assignee hereof and the disclosures of which are incorporated herein by reference. Alternatively, defatting of the separated aqueous pulse protein solution may be achieved by any other convenient procedure.

The aqueous pulse protein solution may be treated with an adsorbent, such as powdered activated carbon or granulated activated carbon, to remove colour and/or odour compounds. Such adsorbent treatment may be carried out under any convenient conditions, generally at the ambient temperature of the separated aqueous protein solution. For powdered activated carbon, an amount of about 0.025% to about 5% w/v, preferably about 0.05% to about 2% w/v, is employed. The adsorbing agent may be removed from the pulse protein solution by any convenient means, such as by filtration.

The resulting aqueous pulse protein solution may be diluted generally with about 0.1 to about 10 volumes, preferably about 0.5 to about 2 volumes of aqueous diluent, in order to decrease the conductivity of the aqueous pulse protein solution to a value of generally below about 105 mS, preferably about 4 to about 21 mS. Such dilution is usually effected using water, although dilute salt solution, such as sodium chloride or calcium chloride, having a conductivity up to about 3 mS, may be used.

The diluent with which the pulse protein solution is mixed generally has the same temperature as the pulse protein solution, but the diluent may have a temperature of about 1° to about 100° C., preferably about 15° to about 65° C., more preferably about 50° to about 60° C.

The optionally diluted pulse protein solution then is adjusted in pH to a value of about 1.5 to about 4.4, preferably about 2 to about 4, by the addition of any suitable food grade acid, such as hydrochloric acid or phosphoric acid, to result in an acidified aqueous pulse protein solution, preferably a clear acidified aqueous pulse protein solution. The acidified aqueous pulse protein solution has a conductivity of generally below about 110 mS for a diluted pulse protein solution or generally below about 115 mS for an undiluted pulse protein solution, in both cases preferably about 4 to about 26 mS.

As mentioned above, as an alternative to the earlier separation of the residual pulse protein source, the aqueous pulse protein solution and the residual pulse protein source material, may be optionally diluted and acidified together and then the acidified aqueous pulse protein solution is clarified and separated from the residual pulse protein source material by any convenient technique as discussed above. The acidified aqueous pulse protein solution may optionally be defatted, optionally treated with an adsorbent and optionally treated with defoamer as described above.

The acidified aqueous pulse protein solution may be subjected to a heat treatment to inactivate heat labile anti-nutritional factors, such as trypsin inhibitors, present in such solution as a result of extraction from the pulse protein source material during the extraction step. Such a heating step also provides the additional benefit of reducing the microbial load. Generally, the protein solution is heated to a temperature of about 70° to about 160° C., preferably about 80° to about 120° C., more preferably about 85° to about 95° C., for about 10 seconds to about 60 minutes, preferably about 10 seconds to about 5 minutes, more preferably about 30 seconds to about 5 minutes. The heat treated acidified pulse protein solution then may be cooled for further processing as described below, to a temperature of about 2° to about 65° C., preferably about 50° C. to about 60° C.

If the optionally diluted, acidified and optionally heat treated pulse protein solution is not transparent it may be clarified by any convenient procedure such as filtration or centrifugation.

If of adequate purity, the resulting acidified aqueous pulse protein solution may be directly dried to produce a pulse protein product. Alternatively, the acidified aqueous protein solution may be adjusted in pH to about 6.0 to about 8.0 and further processed as described below. In order to provide a pulse protein product having a decreased impurities content and a reduced salt content, such as a pulse protein isolate, the acidified aqueous pulse protein solution may be processed as described below prior to drying or pH adjustment.

The acidified aqueous pulse protein solution may be concentrated to increase the protein concentration thereof while maintaining the ionic strength thereof substantially constant. Such concentration generally is effected to provide a concentrated pulse protein solution having a protein concentration of about 50 to about 300 g/L, preferably about 100 to about 200 g/L.

The concentration step may be effected in any convenient manner consistent with batch or continuous operation, such as by employing any convenient selective membrane technique, such as ultrafiltration or diafiltration, using membranes, such as hollow-fibre membranes or spiral-wound membranes, with a suitable molecular weight cut-off, such as about 1,000 to about 1,000,000 Daltons, preferably about 1,000 to about 100,000 Daltons, having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass therethrough while preventing higher molecular weight species from so doing. The low molecular weight species include not only the ionic species of the salt but also low molecular weight materials extracted from the source material, such as carbohydrates, pigments, low molecular weight proteins and anti-nutritional factors, such as trypsin inhibitors, which are themselves low molecular weight proteins. The molecular weight cut-off of the membrane is usually chosen to ensure retention of a significant proportion of the protein in the solution, while permitting contaminants to pass through having regard to the different membrane materials and configurations.

The concentrated pulse protein solution then may be subjected to a diafiltration step using water or a dilute saline solution. The diafiltration solution may be at its natural pH or at a pH equal to that of the protein solution being diafiltered or at any pH value in between. Such diafiltration may be effected using from about 1 to about 40 volumes of diafiltration solution, preferably about 2 to about 25 volumes of diafiltration solution. In the diafiltration operation, further quantities of contaminants are removed from the aqueous pulse protein solution by passage through the membrane with the permeate. This purifies the aqueous protein solution and may also reduce its viscosity. The diafiltration operation may be effected until no significant further quantities of contaminants or visible colour are present in the permeate or until the retentate has been sufficiently purified so as, when dried, to provide a pulse protein isolate with a protein content of at least about 90 wt % (N×6.25) d.b. Such diafiltration may be effected using the same membrane as for the concentration step. However, if desired, the diafiltration step may be effected using a separate membrane with a different molecular weight cut-off, such as a membrane having a molecular weight cut-off in the range of about 1,000 to about 1,000,000 Daltons, preferably about 1,000 to about 100,000 Daltons, having regard to different membrane materials and configuration.

Alternatively, the diafiltration step may be applied to the acidified aqueous protein solution prior to concentration or to partially concentrated acidified aqueous protein solution. Diafiltration may also be applied at multiple points during the concentration process. When diafiltration is applied prior to concentration or to the partially concentrated solution, the resulting diafiltered solution may then be additionally concentrated. The viscosity reduction achieved by diafiltering multiple times as the protein solution is concentrated may allow a higher final, fully concentrated protein concentration to be achieved. This reduces the volume of material to be dried.

The concentration step and the diafiltration step may be effected herein in such a manner that the pulse protein product subsequently recovered contains less than about 90 wt % protein (N×6.25) d.b., such as at least about 60 wt % protein (N×6.25) d.b. By partially concentrating and/or partially diafiltering the aqueous pulse protein solution, it is possible to only partially remove contaminants. This protein solution may then be dried or pH adjusted and further processed as described below to provide a pulse protein product with lower levels of purity.

An antioxidant may be present in the diafiltration medium during at least part of the diafiltration step. The antioxidant may be any convenient antioxidant, such as sodium sulfite or ascorbic acid. The quantity of antioxidant employed in the diafiltration medium depends on the materials employed and may vary from about 0.01 to about 1 wt %, preferably about 0.05 wt %. The antioxidant serves to inhibit the oxidation of any phenolics present in the pulse protein solution.

The optional concentration step and the optional diafiltration step may be effected at any convenient temperature, generally about 2° to about 65° C., preferably about 50° to about 60° C., and for the period of time to effect the desired degree of concentration and diafiltration. The temperature and other conditions used to some degree depend upon the membrane equipment used to effect the membrane processing, the desired protein concentration of the solution and the efficiency of the removal of contaminants to the permeate.

As alluded to earlier, pulses contain anti-nutritional trypsin inhibitors. The level of trypsin inhibitor activity in the final pulse protein product can be controlled by the manipulation of various process variables.

As noted above, heat treatment of the acidified aqueous pulse protein solution may be used to inactivate heat-labile trypsin inhibitors. The partially concentrated or fully concentrated acidified aqueous pulse protein solution may also be heat treated to inactivate heat labile trypsin inhibitors. When the heat treatment is applied to the partially concentrated acidified aqueous pulse protein solution, the resulting heat treated solution may then be additionally concentrated.

In addition, the concentration and/or diafiltration steps may be operated in a manner favorable for removal of trypsin inhibitors in the permeate along with the other contaminants Removal of the trypsin inhibitors is promoted by using a membrane of larger pore size, such as 30,000 to 1,000,000 Da, operating the membrane at elevated temperatures, such as 30° to 65° C., preferably about 50° to about 60° C. and employing greater volumes of diafiltration medium, such as 10 to 40 volumes.

Acidifying and membrane processing the pulse protein solution at a lower pH, such as 1.5 to 3, may reduce the trypsin inhibitor activity relative to processing the solution at higher pH, such as 3 to 4.4. When the protein solution is concentrated and/or diafiltered at the low end of the pH range, it may be desired to raise the pH of the protein solution prior to drying. The pH of the concentrated and/or diafiltered protein solution may be raised to the desired value, for example pH 3, by the addition of any convenient food grade alkali, such as sodium hydroxide.

Further, a reduction in trypsin inhibitor activity may be achieved by exposing pulse materials to reducing agents that disrupt or rearrange the disulfide bonds of the inhibitors. Suitable reducing agents include sodium sulfite, cysteine and N-acetylcysteine.

The addition of such reducing agents may be effected at various stages of the overall process. The reducing agent may be added with the pulse protein source material in the extraction step, may be added to the clarified aqueous pulse protein solution following removal of residual pulse protein source material, may be added to the diafiltered retentate before drying or may be dry blended with the dried pulse protein product. The addition of the reducing agent may be combined with the heat treatment step and membrane processing steps, as described above.

If it is desired to retain active trypsin inhibitors in the concentrated protein solution, this can be achieved by eliminating or reducing the intensity of the heat treatment step, not utilizing reducing agents, operating the concentration and diafiltration steps at the higher end of the pH range, such as 3 to 4.4, utilizing a concentration and diafiltration membrane with a smaller pore size, operating the membrane at lower temperatures and employing fewer volumes of diafiltration medium.

The optionally concentrated and optionally diafiltered protein solution may be subject to a further defatting operation, if required, as described in U.S. Pat. Nos. 5,844,086 and 6,005,076. Alternatively, defatting of the optionally concentrated and optionally diafiltered protein solution may be achieved by any other convenient procedure.

The optionally concentrated and optionally diafiltered aqueous protein solution may be treated with an adsorbent, such as powdered activated carbon or granulated activated carbon, to remove colour and/or odour compounds. Such adsorbent treatment may be carried out under any convenient conditions, generally at the ambient temperature of the protein solution. For powdered activated carbon, an amount of about 0.025% to about 5% w/v, preferably about 0.05% to about 2% w/v, is employed. The adsorbent may be removed from the pulse protein solution by any convenient means, such as by filtration.

The optionally concentrated and optionally diafiltered aqueous pulse protein solution may be dried by any convenient technique, such as spray drying or freeze drying. A pasteurization step may be effected on the pulse protein solution prior to drying or pH adjustment and further processing as described below. Such pasteurization may be effected under any desired pasteurization conditions. Generally, the optionally concentrated and optionally diafiltered pulse protein solution is heated to a temperature of about 55° to about 70° C., preferably about 60° to about 65° C., for about 30 seconds to about 60 minutes, preferably about 10 minutes to about 15 minutes. The pasteurized pulse protein solution then may be cooled for drying or pH adjustment and further processing as described below, preferably to a temperature of about 25° to about 40° C.

The dry pulse protein product has a protein content greater than about 60 wt %. Preferably, the dry pulse protein product is an isolate with a protein content in excess of about 90 wt % protein, preferably at least about 100 wt %, (N×6.25) d.b.

The pulse protein product produced herein is soluble in an acidic aqueous media. The pulse protein product is also suitable for use in frozen dessert mixes, used to prepare frozen dessert products, as described above.

As an alternative to drying the optionally concentrated, optionally diafiltered and optionally pasteurized aqueous pulse protein solution, it may be processed by a variety of procedures to provide a pH adjusted pulse protein product and to manipulate the functional properties thereof.

In one such procedure, the acidified aqueous pulse protein solution, the partially concentrated pulse protein solution or the concentrated pulse protein solution described above, following optional dilution with about 0.1 to about 6 volumes of water, preferably about 1 to about 4 volumes of water, may be adjusted to a pH about 6 to about 8, preferably about 6.5 to about 7.5. The entire sample then may be dried or any precipitated solids may be collected by centrifugation and only these dried to form the product. Alternatively, the pH 6 to 8 solution may be heated to a temperature of about 70° to about 160° C., for about 2 seconds to about 60 minutes, preferably about 80° to about 120° C., for about 15 seconds to about 15 minutes, more preferably about 85° to about 95° C., for about 1 to about 5 minutes, prior to drying the entire sample or collecting any precipitated solids by centrifugation and drying these to form the product.

As a further alternative, the acidified aqueous pulse protein solution may be adjusted in pH to about 6 to about 8, preferably about 6.5 to about 7.5 prior to the optional concentration and optional diafiltration steps above. The pH adjusted protein solution resulting from the optional concentration and optional diafiltration steps may then be dried or centrifuged to collect any insoluble pulse protein material, which may be dried. Alternatively, the pH adjusted protein solution resulting from the optional concentration and optional diafiltration steps may be heat treated and then dried or centrifuged to collect any insoluble pulse protein material, which may be dried.

Alternatively, the pulse protein product prepared by drying the optionally concentrated, optionally diafiltered and optionally pasteurized aqueous pulse protein solution may be redissolved in water and the pH of the resulting acidic aqueous solution is raised to a pH of about 6 to about 8, preferably 6.5 to about 7.5, in any convenient manner, such as by the use of aqueous sodium hydroxide solution, prior to drying. Alternatively, any precipitate formed on adjustment of the pH to about 6 to about 8 is recovered by centrifugation and these solids are dried to yield a pulse protein product.

As a further alternative, the pH 6 to 8 solution may be heated to a temperature of about 70° C. to about 160° C., for about 2 seconds to about 60 minutes, preferably about 80° to about 120° C., for about 15 seconds to about 15 minutes, more preferably about 85° to about 95° C., for about 1 to about 5 minutes, prior to drying the entire sample, or in yet another alternative procedure, recovering by centrifugation and drying only any insoluble solids present in the heat treated sample.

The dry pulse protein product has a protein content of at least about 60 wt % (N×6.25) d.b. Preferably, the dry pulse protein product is an isolate with a high protein content, in excess of about 90 wt % protein, preferably at least about 100 wt % protein (N×6.25) d.b.

The pH adjusted pulse protein product is also suitable for use in frozen dessert mixes, used to prepare frozen dessert products, as described above.

### EXAMPLES

### Example 1

This Example illustrates the production of the YP701 pea protein isolates used in the preparation of the frozen desserts.

‘a’ kg of ‘b’ was combined with ‘c’ L of 0.15 M CaCl₂ solution at 60° C. and agitated for 30 minutes to provide an aqueous protein solution. The residual solids were removed by centrifugation to produce a centrate having a protein content of ‘d’% by weight. ‘e’ L of centrate was added to ‘f’ L of RO water at 60° C. and the pH of the sample lowered to ‘g’ with diluted HCl. The diluted and acidified centrate was further clarified by filtration to provide a clear protein solution with a protein content of ‘h’% by weight.

The filtered protein solution was reduced in volume from ‘i’ L to ‘j’ L by concentration on a polyethersulfone membrane, having a molecular weight cutoff of ‘k’ Daltons, operated at a temperature of about ‘1’° C. At this point the acidified protein solution, with a protein content of ‘m’ wt %, was diafiltered with ‘n’ L of RO water, with the diafiltration operation conducted at about ‘o’° C. The resulting diafiltered solution was then further concentrated to provide ‘p’ kg of acidified, diafiltered, concentrated protein solution. The protein solution before spray drying had a weight of ‘q’ and a protein content of ‘r’ % by weight, which represented a yield of ‘s’ wt % of the initial centrate that was further processed. The acidified, diafiltered, concentrated protein solution was dried to yield a product found to have a protein content of ‘t’ wt % (N×6.25) d.b. The product was termed ‘u’ YP701 protein isolate.

TABLE 1
Parameters for the runs to produce YP701

| u | YP01-E19-11A | YP03-J05-11A |
|---|---|---|
| a | 20 | 30 |
| b | yellow split pea flour | yellow pea protein concentrate |
| c | 200 | 300 |
| d | 1.32 | 3.50 |
| e | 186.5 | 254.9 |
| f | 225.8 | 346.2 |
| g | 3.34 | 3.26 |
| h | 0.58 | 1.62 |
| i | 400 | 548 |
| j | 35 | 51 |
| k | 100,000 | 10,000 |
| l | 58 | 56 |
| m | 4.94 | 10.03 |
| n | 350 | 510 |
| o | 60 | 58 |
| p | 21.52 | n/a |
| q | 21.52 | 52.98 |
| r | 7.54 | 9.85 |
| s | 65.9 | 58.5 |
| t | 103.19 | 102.62 |

### Example 2

This Example illustrates the production of frozen desserts used for sensory evaluation. Frozen desserts were prepared using either YP01-E19-11A YP701, prepared as described in Example 1, or Nutralys S85F (Roquette America Inc., Keokuk, Iowa), a commercial pea protein isolate recommended for use in applications including dairy-type products.

Sufficient protein powder to supply 14.4 g of protein was weighed out and approximately 550 ml of purified drinking water was added. The sample was stirred until the protein was well dispersed (Nutralys S85F) or completely solubilized (YP01-E19-11A YP701). The pH of the Nutralys S85F solution was 7.52. The pH of the YP01-E19-11A YP701 solution was adjusted from 3.85 to 7.50 using food grade NaOH. To the solutions was then added 7.2 g of soybean oil (Crisco Vegetable Oil, Smucker Foods of Canada Co., Markham, ON) and the volumes of the samples brought up to 600 ml with additional water. The samples were then processed at 5,000 rpm for 3 minutes on a Silverson L4RT mixer equipped with a fine emulsor screen.

Samples of each soy protein solution (507.16 g) were weighed out and then pure vanilla extract (1.99 g) (Club House, McCormick Canada, London, ON) and granulated sugar (89.85 g) (Rogers Fine Granulated, Lantic Inc., Montreal, QC) added and the mixture stirred until the sugar completely dissolved. The pH of the mixes was determined. The mix prepared with Nutralys S85F had a pH of 7.38. The pH of the mix prepared with YP01-E19-11A YP701 was 7.47. The mixes were then chilled to a temperature of 9° C. Each chilled mix was transferred to the bowl of a Cuisinart ICE-50BCC ice cream maker. The ice cream maker was run for 45 minutes yielding a semisolid frozen dessert. The temperature of the freshly prepared Nutralys S85F frozen dessert was −4° C. The temperature of the freshly prepared YP01-E19-11A YP701 frozen dessert was −3° C. The products were transferred to plastic tubs and stored overnight in a freezer at about −8° C. The next day the samples, having a temperature of −6° C., were presented to the sensory panel.

### Example 3

This Example illustrates the sensory evaluation of the frozen desserts.

Samples of the frozen desserts were transferred to small cups then presented blindly to an informal panel with 8 panelists. The panel was asked to identify which sample they preferred the flavour of. Seven out of eight panelists preferred the flavour of the dessert prepared with YP01-E19-11A YP701.

### Example 4

This Example illustrates the production of frozen desserts used for sensory evaluation. Frozen desserts were prepared using either YP03-J05-11A YP701, prepared as described in Example 1, or Nutralys S85F (Roquette America Inc., Keokuk, Iowa), a commercial pea protein isolate recommended for use in applications including dairy-type products.

The formulations used to prepare the frozen desserts are shown in Table 2. Each frozen dessert was formulated to contain 4.26% protein. The as-is protein content of the YP03-J05-11A YP701 was 99.56% and that of the Nutralys S85F was 78.52%.

TABLE 2
Frozen dessert formulations

| | YP03-J05-11A | | Nutralys | |
|---|---|---|---|---|
| | YP701 formulation | | S85F formulation | |
| ingredient | weight (g) | % | weight (g) | % |
| YP03-J05-11A YP701 | 29.95 | 4.28 | 0 | 0 |
| Nutralys S85F | 0 | 0 | 37.98 | 5.43 |
| coconut oil | 56 | 8 | 56 | 8 |
| sugar | 84 | 12 | 84 | 12 |
| corn syrup solids (42 DE) | 28 | 4 | 28 | 4 |
| maltodextrin | 49 | 7 | 49 | 7 |
| guar gum | 2.1 | 0.3 | 2.1 | 0.3 |
| carrageenan | 0.42 | 0.06 | 0.42 | 0.06 |
| polysorbate 80 | 1.05 | 0.15 | 1.05 | 0.15 |
| natural vanilla extract | 3.5 | 0.5 | 3.5 | 0.5 |
| flavour | | | | |
| water plus NaOH or HCl | 445.98 | 63.71 | 437.95 | 62.56 |
| Total | 700 | 100 | 700 | 100 |

The protein powder was mixed with 400 g of water until dissolved or well dispersed. The pH of the sample was measured and adjusted to 7.25 with food grade NaOH or HCl solution as necessary. Additional water was then added to bring the total weight to 475.93 g. The polysorbate 80 (Tween 80, Uniqema, New Castle, Del.) and vanilla flavouring (Natural Vanilla Extract Flavor Prod22213, Carmi Flavors, Port Coquitlam, BC) were added to the protein solution. The sugar (Rogers Fine Granulated, Lantic Inc., Montreal, QC), corn syrup solids (Star-Dri 42R, A.E. Staley Manufacturing Co., Decatur, Ill.), maltodextrin (Maltrin M510, Grain Processing Corporation, Muscatine, Iowa), guar gum (Procol F, Polypro International Inc., Minneapolis, Minn.) and carrageenan (Genuvisco J-DS, C.P. Kelco, Lille Skensved, Denmark) were dry blended. The protein solution was warmed to 40° C. and then the dry ingredients mixed in. The coconut oil (Future Enhancements Marketing Ltd., Chemainus, BC) was melted and then added to the other ingredients. The mixture was pasteurized at 80° C. for 30 seconds and then homogenized with 170 bar pressure on the first stage and 30 bar on the second stage. The mixes were cooled and placed in the refrigerator overnight.

The mixes, having a temperature of about ‘a’° C. were transferred to the bowl of a Cuisinart ICE-50BCC ice cream maker. The ice cream maker was run for ‘b’ minutes to yield a semi-solid frozen dessert having a temperature of about ‘c’° C. The products were transferred to plastic tubs and stored overnight in a freezer. The next day the samples, having a temperature of about ‘d’° C., were presented to the sensory panel.

TABLE 3
Parameters for the freezing of the frozen desserts

| | YP03-J05-11A YP701 formulation | Nutralys S85F formulation |
|---|---|---|
| a | 0.5 | 0 |
| b | 23.67 | 17.92 |
| c | −3 | −3 |
| d | −13.5 | −12.4 |

### Example 5

This Example illustrates the sensory evaluation of the frozen desserts.

Samples of the frozen desserts were transferred to small cups then presented blindly to an informal panel with 8 panelists. The panel was asked to identify which sample had a cleaner flavor and which sample they preferred the flavour of. Seven out of eight panelists indicated that the frozen dessert prepared with YP03-J05-11A YP701 had a cleaner flavor. Seven out of eight panelists preferred the flavour of the dessert prepared with YP03-J05-11A YP701.

### Example 6

This Example illustrates the production of the YP701N2 pea protein isolate used in the preparation of the frozen dessert.

46.3 kg of yellow split pea flour was combined with 300 L of reverse osmosis (RO) purified water at 30° C. and agitated for 30 minutes. 4.53 kg of calcium chloride pellets (95.5%) were added and the mixture stirred for an additional 15 minutes. The residual solids were removed by centrifugation to produce 264 L of centrate having a protein content of 1.94% by weight. 264 L of centrate was added to 185 L of RO water and the pH of the sample lowered to 2.99 with HCl that had been diluted with an equal volume of water. The diluted and acidified centrate was further clarified by filtration to provide a protein solution with a protein content of 0.95% by weight.

The filtered protein solution was reduced in volume from 470 L to 66 L by concentration on a polyethersulfone (PES) membrane, having a molecular weight cutoff of 10,000 Daltons, operated at a temperature of approximately 58° C. At this point the protein solution, with a protein content of 4.75 wt %, was diafiltered with 132 L of RO water, with the diafiltration operation conducted at approximately 59° C. The diafiltered protein solution was then concentrated to 28 L and diafiltered with an additional 140 L of RO water, with the diafiltration operation conducted at approximately 60° C. The concentrated protein solution, having a protein content of 10.13 wt % was diluted with RO water to a protein content of 4.58 wt %. 28.1 kg of this solution, representing a yield of 28.9 wt % of the filtered protein solution, was then adjusted in pH to 6.93 with NaOH solution. The pH adjusted protein solution was then spray dried to yield a product found to have a protein content of 98.72 wt % (N×6.25) d.b. The product was given designation YP07-C20-12A YP701N2.

### Example 7

This Example illustrates the production of frozen desserts used for sensory evaluation. Frozen desserts were prepared using either YP07-C20-12A YP701N2, prepared as described in Example 6, or Nutralys S85F (Roquette America Inc., Keokuk, Iowa), a commercial pea protein isolate recommended for use in applications including dairy-type products.

The formulations used to prepare the frozen desserts are shown in Table 4. Each frozen dessert was formulated to contain 4.26% protein. The as-is protein content of the YP07-C20-12A YP701N2 was 90.90% and that of the Nutralys S85F was 78.52%.

TABLE 4
Frozen dessert formulations

| | YP07-C20-12A | | Nutralys | |
|---|---|---|---|---|
| | YP701N2 formulation | | S85F formulation | |
| ingredient | weight (g) | % | weight (g) | % |
| YP07-C20-12A YP701N2 | 32.8 | 4.69 | 0 | 0 |
| Nutralys S85F | 0 | 0 | 37.98 | 5.43 |
| coconut oil | 56 | 8 | 56 | 8 |
| sugar | 84 | 12 | 84 | 12 |
| corn syrup solids (42 DE) | 28 | 4 | 28 | 4 |
| maltodextrin | 49 | 7 | 49 | 7 |
| guar gum | 2.1 | 0.3 | 2.1 | 0.3 |
| carrageenan | 0.42 | 0.06 | 0.42 | 0.06 |
| polysorbate 80 | 1.05 | 0.15 | 1.05 | 0.15 |
| natural vanilla extract | 3.5 | 0.5 | 3.5 | 0.5 |
| flavour | | | | |
| water plus NaOH or HCl | 443.13 | 63.3 | 437.95 | 62.56 |
| Total | 700 | 100 | 700 | 100 |

The protein powder was mixed with 400 g of water until dissolved or well dispersed. The pH of the sample was measured and adjusted to 7.25 with food grade NaOH or HCl solution as necessary. Additional water was then added to bring the total weight to 475.93 g. The polysorbate 80 (Tween 80, Uniqema, New Castle, Del.) and vanilla flavouring (Natural Vanilla Extract Flavor Prod22213, Carmi Flavors, Port Coquitlam, BC) were added to the protein solution. The sugar (Rogers Fine Granulated, Lantic Inc., Montreal, QC), corn syrup solids (Star-Dri 42R, A.E. Staley Manufacturing Co., Decatur, Ill.), maltodextrin (Maltrin M510, Grain Processing Corporation, Muscatine, Iowa), guar gum (Procol F, Polypro International Inc., Minneapolis, Minn.) and carrageenan (Genuvisco J-DS, C.P. Kelco, Lille Skensved, Denmark) were dry blended. The protein solution was warmed to 40° C. and then the dry ingredients mixed in. The coconut oil (Future Enhancements Marketing Ltd., Chemainus, BC) was melted and then added to the other ingredients. The mixture was pasteurized at 80° C. for 30 seconds and then homogenized with 170 bar pressure on the first stage and 30 bar on the second stage. The mixes were cooled and placed in the refrigerator overnight.

The mixes, having a temperature of about ‘a’° C. were transferred to the bowl of a Cuisinart ICE-50BCC ice cream maker. The ice cream maker was run for ‘b’ minutes to yield a semi-solid frozen dessert having a temperature of about ‘c’° C. The products were transferred to plastic tubs and stored overnight in a freezer. The next day the samples, having a temperature of about ‘d’° C., were presented to the sensory panel.

TABLE 5
Parameters for the freezing of the frozen desserts

| | YP07-C20-12A YP701N2 formulation | Nutralys S85F formulation |
|---|---|---|
| a | 0 | 0 |
| b | 18.83 | 17.92 |
| c | −3 | −3 |
| d | −15.3 | −12.7 |

### Example 8

This Example illustrates the sensory evaluation of the frozen desserts.

Samples of the frozen desserts were transferred to small cups then presented blindly to an informal panel with 8 panelists. The panel was asked to identify which sample had a cleaner flavor and which sample they preferred the flavour of. Seven out of eight panelists indicated that the frozen dessert prepared with YP07-C20-12A YP701N2 had a cleaner flavor. Seven out of eight panelists preferred the flavour of the dessert prepared with YP07-C20-12A YP701N2.

### SUMMARY OF THE DISCLOSURE

In summary of this disclosure, frozen dessert mixes, used in the production of frozen dessert products having favorable flavor properties are provided using pulse protein products. Modifications are possible within the scope of this invention.

What we claim is:

1. A frozen dessert mix having a composition that includes protein, fat, flavourings, sweetener, stabilizers and emulsifiers in sufficient proportions to provide a desired composition of frozen dessert product, wherein the protein component is provided at least in part by
(a) a pulse protein product having a protein content of at least about 60 wt % (N×6.25) d.b. and being soluble at said pH values of less than 4.4 and heat stable at such pH values, or
(b) alternatively adjusted in pH to a pH of about 6 to about 8 and further processed by drying the product, recovering and drying any precipitated pulse protein material, heat treating and then drying the product or heat treating the product and recovering and drying any precipitated pulse protein material.

2. The mix of claim 1 wherein said mix has a composition that includes:
0 to about 30 wt % fat
0.1 to about 18 wt % protein
0 to about 45 wt % sweetener
0 to about 3 wt % stabilizer
0 to about 4 wt % emulsifier

3. The mix of claim 1 wherein said mix has a composition that includes:
0 to about 18 wt % fat
0.1 to about 6 wt % protein
0 to about 35 wt % sweetener
0 to about 1 wt % stabilizer
0 to about 2 wt % emulsifier

4. The mix of claim 1 which contains no dairy ingredients and can be classified as a dairy analogue frozen dessert mix.

5. The mix of claim 1 which contains no dairy ingredients and can be classified as a dairy alternative frozen dessert mix.

6. The mix of claim 1 which contains a blend of plant and dairy ingredients.
